(19) United States
(12) Patent Application Publication
(10) Pub. No.: US 2024/0368819 A1
(43) Pub. Date: Nov. 7, 2024

(54) LAUNDRY ACCESSORY FOR DISPENSING LAUNDRY CHEMICALS AND DETERGENT

(71) Applicant: YKY Group Inc., Temecula, CA (US)

(72) Inventor: Yusuf K. YAQUBI, Temecula, CA (US)

(21) Appl. No.: 18/652,493

(22) Filed: May 1, 2024

Related U.S. Application Data
(60) Provisional application No. 63/463,257, filed on May 1, 2023.

(51) Int. Cl. D06F 39/02; B05B 7/00; B05B 9/04; B05B 12/00

(52) U.S. Cl. CPC D06F 39/022; B05B 7/0093; B05B 9/04; B05B 12/002

(57) ABSTRACT

A laundry accessory may include a hand truck defining a two wheeled dolly device, the hand truck further comprising a frame defining laterally spaced longitudinally extending side rails, said frame further defining head and base ends. A laundry accessory may include a storage unit coupled to and extending laterally between the side rails, wherein the storage unit is located between the head and base ends. A laundry accessory may include a hose extending between the head and base ends, wherein the hose is configured to be coupled to a container at a first end proximate to the base end. A laundry accessory may include a spray nozzle coupled to a second end of the hose proximate the head end.

### CROSS-REFERENCE TO RELATED APPLICATIONS

This U.S. Non-Provisional patent application claims the benefit of U.S. Provisional Application No. 63/463,257 filed on May 1, 2023, and titled Laundry Accessory for Dispensing Laundry Chemicals and Detergent, which is fully incorporated herein by reference as if fully set forth herein.

### TECHNICAL FIELD

The present disclosure relates generally to laundry systems, specifically, a laundry accessory for dispensing laundry chemicals and detergent.

### BACKGROUND

Liquid detergent and fabric softeners are staple products for households and laundromats around the world. Large one-to-two-gallon containers are typically used to store these liquids and related laundry chemicals, providing users and families with well over one hundred laundry-loads-worth of material in a single container. When full, these containers are heavy and onerous to move. Doing a load of laundry can be a tedious activity, especially for those with a limited range of motion or difficulty carrying heavy objects. Laundry accessories may be used to assist users in dispensing laundry chemicals and liquid detergents. These accessories may be used to hold the chemical and detergent containers in place for the user. For example, these accessories may hold the containers at an angle for the user to dispense the liquid from the container and into the measuring cup that is typically purchased with the container. However, these accessories are stationary and meant to hold the containers in place. This leaves users with little options to move or stow the containers. Moreover, the accessories do not help users properly dose the detergent or chemical for the specific load of laundry being done, and do little to prevent unnecessary spills, wasting detergent and costing consumers.

### SUMMARY

A laundry detergent and chemical accessory to washing machines is disclosed herein, in accordance with various embodiments.

In some aspects, the techniques described herein relate to a laundry accessory, including: a hand truck defining a two wheeled dolly device, the hand truck further including a frame defining laterally spaced longitudinally extending side rails, said frame further defining head and base ends, a storage unit coupled to and extending laterally between the side rails, wherein the storage unit is located between the head and base ends, a hose extending between the head and base ends, wherein the hose is configured to be coupled to a container at a first end proximate to the base end, and a spray nozzle coupled to a second end of the hose proximate the head end.

### BRIEF DESCRIPTION OF THE DRAWINGS

A more complete understanding of the subject matter may be derived by referring to the detailed description and claims when considered in conjunction with the following figures, wherein like reference numbers refer to similar elements throughout the figures.

FIG. 1 illustrates a perspective view of a laundry accessory apparatus, in accordance with various embodiments;

FIG. 2 illustrates a side view of a laundry accessory apparatus, in accordance with various embodiments; and

FIG. 3 illustrates a schematic view of a user interface, in accordance with various embodiments.

### DETAILED DESCRIPTION

The following detailed description is merely illustrative in nature and is not intended to limit the embodiments of the subject matter of the application and uses of such embodiments. As used herein, the words “exemplary” and “example” mean “serving as an example, instance, or illustration.” Any implementation or embodiment described herein as exemplary, or an example is not necessarily to be construed as preferred or advantageous over other implementations. Furthermore, there is no intention to be bound by any expressed or implied theory presented in the preceding technical field, background, or the following detailed description.

A laundry detergent and chemical accessory to washing machines is disclosed herein, in accordance with various embodiments. The laundry accessory may include a portable hose and nozzle configured to dispense laundry detergent by a vacuum pump. The hose and nozzle may dispense laundry detergent into a washing machine's detergent compartment from the original container of the detergent, fabric softener, or other laundry chemicals, or from any container housing detergent, softener, or other laundry chemicals.

In some aspects, the techniques described herein relate to a laundry accessory, including: a hand truck defining a two wheeled dolly device, the hand truck further including a frame defining laterally spaced longitudinally extending side rails, said frame further defining head and base ends, a storage unit coupled to and extending laterally between the side rails, wherein the storage unit is located between the head and base ends, a hose extending between the head and base ends, wherein the hose is configured to be coupled to a container at a first end proximate to the base end, and a spray nozzle coupled to a second end of the hose proximate the head end.

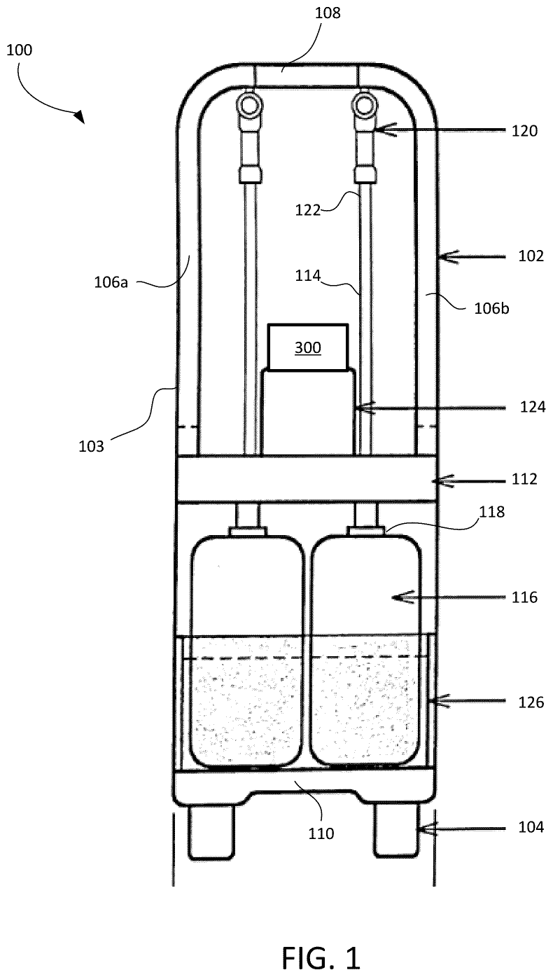

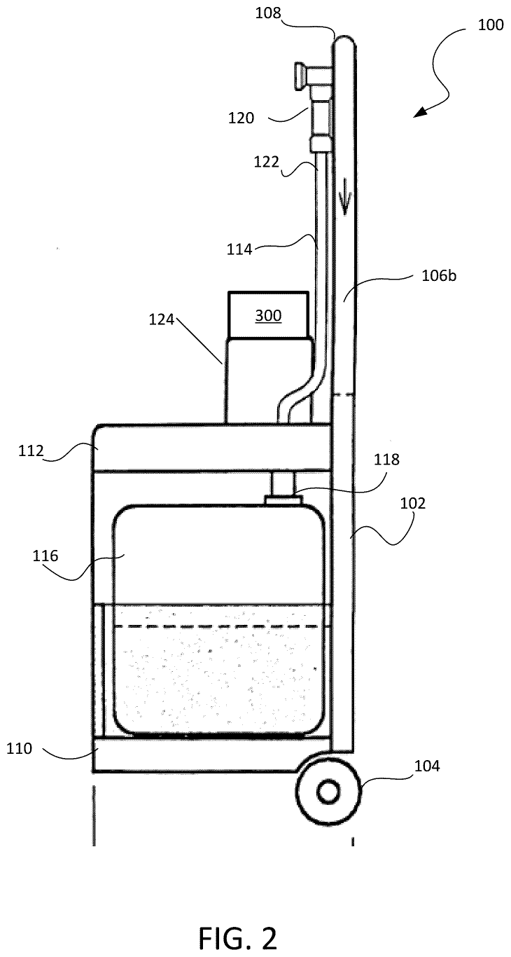

As shown in FIGS. 1 and 2, a laundry accessory 100 includes a hand truck 102 defining a two wheeled dolly device. The hand truck 102 may include at least two wheels 104, enabling users to move the laundry accessory 100 by rolling the hand truck 102. In various embodiments, the hand truck 102 may further include a frame 103 defining laterally spaced longitudinally extending side rails 106a/b. The side rails 106a/106b may be fixed. Alternatively, the side rails 106a/106b may be longitudinally telescoping side rails that enable the user to push down the side rails (i.e., collapsing rails) to reduce the length of the side rails for the user, and to enable easy stowing and storage in smaller spaces. In some aspects, the frame 103 may further define head 108 and base 110 ends. The head 108 and base 110 ends may be substantially perpendicular to the side rails 106a/b. In various embodiments, the longitudinally extending side rails 106a/b of the frame 103 may not exceed a width of 1-2 feet (ft.), 2.1-3 ft., 3.1-4 ft., or 4 ft. In various embodiments, the hand truck 102 (wheel 104 to head end 108) may not exceed a height of 2-3 ft., 3.1-4 ft., or 4 ft. In various embodiments, the base end 110 may not exceed a width of 6 inches (in.)-1 ft., 1.1-2 ft., 2.1-3 ft., 3.1-4 ft., or 4 ft.

In some respects, the hand truck 102 may be comprised of any suitable metal, such as, for example, stainless steel, copper, iron, aluminum, brass, alloys or combinations thereof, and the like. In other aspects, the hand truck 102 may be comprised of a thermoplastic, a high-density polyethylene, composites thereof, and the like.

In various embodiments, the laundry accessory 100 may include a storage unit 112 coupled to and extending laterally between the side rails 106a/b. The storage unit 112 may be located between the head 108 and base ends 110. The storage unit 112 may define a cavity for storing a retractable hose (discussed in further detail below). The storage unit 112 may optionally define at least one channel allowing a retractable hose to traverse therethrough. In some embodiments, the storage unit 112 may define a pair of channels, each allowing a retractable hose to traverse therethrough. The storage unit 112 may be comprised of any suitable metal, such as, for example, stainless steel, copper, iron, aluminum, brass, alloys or combinations thereof, and the like. In other aspects, the storage unit 112 may be comprised of a thermoplastic, a high-density polyethylene, composites thereof, and the like.

In some embodiments, the laundry accessory 100 may include a vacuum pump 124. The vacuum pump 124 may be coupled to the storage unit 112. In some aspects, the vacuum pump 124 may rest on the storage unit, preferably in a corresponding recess of the storage unit 112. In various embodiments, the vacuum pump 124 may be coupled to any aspect of the hand truck 102.

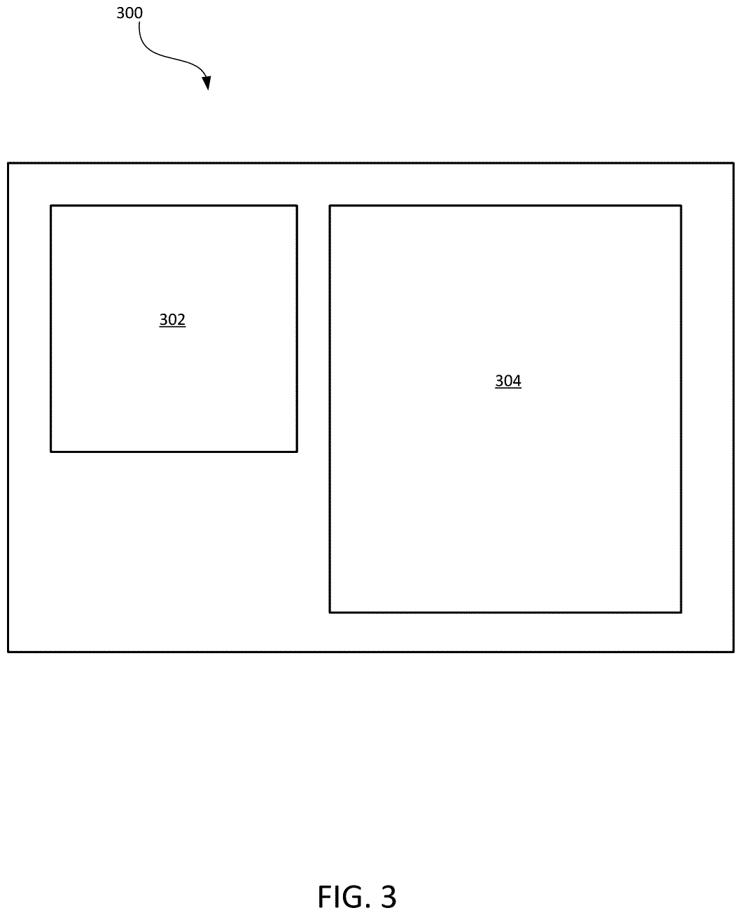

In various embodiments, the laundry accessory 100 may include a user interface 300 electrically coupled to the vacuum pump 124. As will be discussed in further detail with reference to FIG. 3, the user interface 300 may help the user control the flow of laundry chemicals to a washing machine. Moreover, laundry accessory 100, in conjunction with the user interface 300, may optimize the amount of laundry chemical to be used based on the size of a load of laundry, the material and color of the laundry, and the heat to be used during the wash cycle.

In some aspects, the laundry accessory 100 may include at least one hose 114 extending between the head 108 and base 110 ends. The hose 114 may be coupled to the vacuum pump 124. The hose 114 may be coupled to a container 116 at a first end 118 proximate to the base end 110. The container 116 may contain laundry chemicals, such as laundry detergent, fabric softener, and the like. The container 116 may be secured to the hand truck 102 by a panel 126. The panel 126 may prevent the container 116 from slipping off the base end 110. The hose 114 may be retractable, retracting to and extending through the storage unit 112.

The hose 114 may be comprised of a rubber, thermoplastic rubber, polyvinyl fluoride (PVC), polyurethane, neoprene, silicone, polyethylene, coated fabric, and the like. The hose 114 may be comprised of any suitable metal, such as, for example, stainless steel, copper, iron, aluminum, brass, alloys or combinations thereof, and the like.

The laundry accessory 100 may include a spray nozzle 120 coupled to a second end 122 of the hose 114 proximate the head end 108 of the hand truck 102. The spray nozzle 120 may be removably coupled to a clip defined by the head end 108 of the hand truck 102. Alternatively, a clip may be coupled to the head end 108 of the hand truck 102, and the spray nozzle 120 may be removably coupled to the clip. The clip may be fastened to or clipped onto the head end 108.

The spray nozzle 120 may include a pistol grip trigger, button, or tunable valve, and the like, or any other means of controlling the flow of material through the spray nozzle 120. To deliver detergent, fabric softener, or other laundry chemicals into a washing machine, the user may press the pistol grip trigger or button, or turn a valve or otherwise manipulate the nozzle 120, activating the vacuum pump 124 and driving a flow of laundry chemical from the container 116 to the nozzle 120. The user may manually control the amount of chemical being delivered to the washing machine or may preselect the amount of chemical to be automatically delivered to the washing machine.

FIG. 3 illustrates a schematic view of a user interface, in accordance with various embodiments.

In various embodiments, the laundry accessory 100 may include a programmable user interface 300. The user interface may be powered by a power source 302. The power source 302 may be a wired or wireless power source. In various embodiments, the user interface 300 may display a plurality of selections for the user (represented on display 304), such as a first selection, a second selection, a third selection, etc. Each selection may represent at least one laundry setting, such as, for example, SMALL LOAD, MEDIUM LOAD, LARGE LOAD, and/or, WHITE, COLORS, DARK, and/or, COLD, WARM, HOT, and the like. Each selection may represent either just one laundry setting or a combination of multiple settings. For example, a first selection may represent a SMALL LOAD setting, a second selection may represent a DARK setting, and a third selection may represent a COLD setting. Alternatively, a first selection may represent a combination setting of SMALL LOAD/DARK/COLD, a second selection may represent a combination setting of MEDIUM LOAD/WHITE/HOT, and so on. Each selection of the plurality of selections may be programmable and configured to represent any number of laundry settings.

In selecting a selection from the plurality of selections displayed on the user interface 300, the user may control the flow of laundry chemicals to a washing machine. In preselecting the amount of chemical to deliver to the washing the machine, the laundry accessory 100, in conjunction with the user interface 300, may optimize the amount of laundry chemical to be used based on the size of a load of laundry, the material and color of the laundry, and the heat to be used during the wash cycle.

In some aspects, the systems described herein relate to a laundry accessory, including: a hand truck defining a two wheeled dolly device, the hand truck further including a frame defining laterally spaced longitudinally extending side rails, said frame further defining head and base ends, a storage unit coupled to and extending laterally between the side rails, wherein the storage unit is located between the head and base ends; a hose extending between the head and base ends, wherein the hose is configured to be coupled to a container at a first end proximate to the base end; and a spray nozzle coupled to a second end of the hose proximate the head end.

The above is presented to describe specific attributes of this invention. The inventor has contemplated that this system could be used within any residential and commercial laundry system. This description is not meant to limit the scope of this disclosure.

The invention will be especially pertinent to those who struggle with lifting and moving heavy objects, such as a laundry detergent bottle. This system is also especially useful for anyone who has limited range of motion. This invention will also be pertinent to any user seeking to achieve consistent cleaning results, improve laundry system reliability, and control costs due to the over-application of detergent.

The preceding detailed description is merely illustrative in nature and is not intended to limit the embodiments of the subject matter or the application and uses of such embodiments.

As used herein, the word “exemplary” means “serving as an example, instance, or illustration.” Any implementation described herein as exemplary is not necessarily to be construed as preferred or advantageous over other implementations. Furthermore, there is no intention to be bound by any expressed or implied theory presented in the preceding technical field, background, or detailed description.

The connecting lines shown in the various figures contained herein are intended to represent exemplary functional relationships and/or physical couplings between the various elements. It should be noted that many alternative or additional functional relationships or physical connections may be present in an embodiment of the subject matter. In addition, certain terminology may also be used herein for the purpose of reference only, and thus are not intended to be limiting, and the terms “first”, “second” and other such numerical terms referring to structures do not imply a sequence or order unless clearly indicated by the context.

The foregoing description refers to elements or nodes or features being “connected” or “coupled” together. As used herein, unless expressly stated otherwise, “connected” means that one element is directly joined to (or directly communicates with) another element, and not necessarily mechanically. Likewise, unless expressly stated otherwise, “coupled” means that one element is directly or indirectly joined to (or directly or indirectly communicates with, electrically or otherwise) another element, and not necessarily mechanically. Thus, although the schematic shown in the figures depict one exemplary arrangement of elements, additional intervening elements, devices, features, or components may be present in an embodiment of the depicted subject matter.

While at least one exemplary embodiment has been presented in the foregoing detailed description, it should be appreciated that a vast number of variations exist. It should also be appreciated that the exemplary embodiment or embodiments described herein are not intended to limit the scope, applicability, or configuration of the claimed subject matter in any way. Rather, the foregoing detailed description will provide those skilled in the art with a convenient road map for implementing the described embodiment or embodiments. It should be understood that various changes can be made in the function and arrangement of elements without departing from the scope defined by the claims, which includes known equivalents and foreseeable equivalents at the time of filing this patent application.

What is claimed is:

1. A laundry accessory, comprising:
a hand truck defining a two wheeled dolly device, the hand truck further comprising a frame comprising laterally spaced longitudinally extending side rails, said frame further comprising a crossbar defining a head end and a base defining a base end;
a storage unit coupled to and extending laterally between the side rails, wherein the storage unit is located between the head and base ends;
a hose configured to be coupled to a container at a first end proximate to the base; and
a spray nozzle coupled to a second end of the hose proximate the crossbar defining the head end.

2. The laundry accessory of claim 1, wherein the side rails are fixed side rails.

3. The laundry accessory of claim 1, wherein the side rails are longitudinally telescoping side rails.

4. The laundry accessory of claim 1, wherein the crossbar defining the head end and base defining the base end are substantially perpendicular to the side rails.

5. The laundry accessory of claim 1, wherein the width between the longitudinally extending side rails is 2 feet.

6. The laundry accessory of claim 1, wherein the height of the hand truck is 3 feet.

7. The laundry accessory of claim 1, wherein the width of the base end of the hand truck is 2 feet.

8. The laundry accessory of claim 1, wherein the storage unit defines a cavity, wherein the cavity is configured to store the hose.

9. The laundry accessory of claim 1, wherein the storage unit defines at least one channel configured to allow the hose to traverse therethrough.

10. The laundry accessory of claim 1, further comprising a vacuum pump, wherein the vacuum pump is coupled to the storage unit and the hose.

11. The laundry accessory of claim 10, further comprising a user interface electrically coupled to the vacuum pump, wherein the user interface is configured to control a flow of laundry chemicals from the container to a washing machine and further configured to optimize an amount of laundry chemical to be used based on the size of a load of laundry, the material and color of the laundry, and/or the heat to be used during a wash cycle.

12. The laundry accessory of claim 11, wherein the user interface is a programmable user interface.

13. The laundry accessory of claim 1, further comprising a panel coupled to the frame and retaining the container within the hand truck.

14. The laundry accessory of claim 1, further comprising a clip for retaining the spray nozzle, the clip coupled to the frame at the crossbar defining the head end of the hand truck.

15. The laundry accessory of claim 1, wherein the spray nozzle includes a pistol grip trigger configured to control a flow of material through the spray nozzle.
